(19) United States
(12) Patent Application Publication
(10) Pub. No.: US 2023/0153413 A1
(43) Pub. Date: May 18, 2023

(54) USER CENTRIC SYSTEM AND METHOD FOR INTERACTION BETWEEN HUMANS AND DEVICES

(71) Applicant: Telia Company AB, SOLNA (SE)

(72) Inventors: Pierre Karlsson, Huddinge (SE); Mats Mägiste, Bromma (SE); Michael Huber, Täby (SE)

(73) Assignee: Telia Company AB, SOLNA (SE)

(21) Appl. No.: 17/916,943

(22) PCT Filed: Apr. 28, 2021
(86) PCT No.: PCT/IB2021/000289

§ 371 Date: Oct. 4, 2022

Related U.S. Application Data
(60) Provisional application No. 63/017,860, filed on Apr. 30, 2020.

(51) Int. Cl. G06F 21/33; G06F 21/62

(52) U.S. Cl. CPC G06F 21/335; G06F 21/6218

(57) ABSTRACT

The present disclosure relates to a user centric system and methods for interaction between humans and devices or between devices. A method performed by a user device or a computing device having a contract with a service provider (SP), comprises: registering on a hub in a system; acquiring/receiving a global ID from the hub, wherein the global ID includes attributes, and wherein the global ID is mapped to a user ID of the user device; registering on the hub using the acquired global ID; wherein a personal hub is allocated to the user device; selecting a service; and creating one or more tokens/certificates for defining capabilities of the selected service. There is also provided a method in a system, a system, and a computing device.

### CROSS REFERENCE TO RELATED APPLICATION

This application is a national stage application, filed under 35 U.S.C. § 371, of International Patent Application No. PCT/IB2021/000289 filed on Apr. 28, 2021, and U.S. Provisional Patent Application No. 63/017,860 filed on Apr. 30, 2020, which are incorporated by reference herein in their entirety.

### FIELD

The present disclosure relates to the field of data communication and, specifically, to a user-centric data communication system and method for interaction between humans and devices in order to ensure the integrity and compliance between digital rights and legal frameworks.

### BACKGROUND

In typical data communication systems, there are no adequate models that provide for the search and consumption of capabilities for potential and contracted services. Further, there are no adequate models that provide for digital service contracts that require the consent of the data owner for information that is to be shared. What is missing is a user-centric approach, where ownership of the data is kept with the user, while still maintaining the opportunity for the user to exist as a customer at various vendors/service providers simultaneously. Such a concept is an open sharing model of services on the user's terms.

Service providers (SPs) need business-related reasons and motivations to join an ecosystem. This can be achieved if the relationship between the SP and the customer is not threatened. Normal solutions risk the exposure of protected customer insights between the SPs, thus endangering the SP's core business. A natural entry point for a user is through a demand driven relationship through the SPs.

The SP is normally not aware of other already existing services in the user domain or ecosystem. Thus, the SP is incapable of combining and/or enriching its own services with other SPs. There is no current automation that exists that would allow a new service discovery/customer offering that will allow a SP in the ecosystem to be able to search for other SPs' capabilities to enable enrichment by combining its own services with others.

Further, there currently exists no hierarchal consent model to ensure users' rights in service-to-service and device relationships in a way that is not vendor specific. There currently exists a problem with a lack of interaction with the user, related to execution of user data. Consent must be owned and be revocable by the user in real time. Current models have a static or vendor defined operation and there is no way of limiting consent to cut inheritance between SPs collaborating on the next sublevel. This results in leakage of user data. There is currently no abstraction between user consent and deployed services. Each consent is gathered by the vendor (SP), resulting in a non-portable and locked-in model where the user in not in control.

Referring to FIG. 1, user preferences and profiles outside a vendor domain cannot be exchanged or delegated to other users within a logical group like a family. Existing models are based on the SPs having full access to user data, or no data at all besides the initial customer information. A group definition can be created by each SP within the customer contract, but this leads to a “lock-in” of all users in the same customer relationship. This could also easily be in violation with General Data Protection Regulation (GDPR) rules. A vendor-independent group definition that makes cross usage of services possible presently does not exist. For example, a user representing a family member, but who is not part of the specific SP cannot use a service without first becoming a customer at the SP service. Missing user preferences and user profiles for the user beyond the customer identity is limiting the SP's ability to add value. Finally, a lack of isolation between the SP's customer data creates mistrust in the ability to protect each SP's customer relations. The result is closed systems without long term user value.

In existing systems, there are no models for securing user acceptance of data shared between SPs, no common models for creating an innovative evolution of user services beyond the scope of one single vendor (SP), no concept for storing a user's wishes available outside a vendor (SP) domain, no single point to revoke delegated sharing rights (GDPR) rights to be forgotten), and no way to automate consent-based browsing of user profile data.

Today and in the foreseeable future, it is not possible to handle the task of accepting continuous changes and consent requests in ecosystems of devices, services, and humans in an understandable and user friendly way. In the future, it will be important for humans, as the owner of data, to have the consent for use of this data in human to device/system interaction. Although artificial intelligence (AI) might be a capability from an SP, it still needs to be on the user's terms, at all times. Because the data belongs to the user, any AI processing that data must obey a user ruleset. Many vendors (SPs) are experimenting with this balance, and risking the user's rights to its data. This is a misinterpretation of data ownership. What is needed is the ability to secure availability and user ownership of data repositories independent of SPs and to assure that the user's desires will be maintained in an open and shared way with the user's consent.

Further, existing models do not recognize the user's rights if they wish to immediately revoke (“right to be forgotten”) service-to-service or device-to-device sharing of user data. Typically, the user is not in control of a common revocation tool, which makes it nearly impossible to revoke SP-to-SP connections. In the current setup of “right to be forgotten,” all logical expressions built around the user itself will also be lost. Rather, a user-centric model, where the user stores all attributes in its own repository and also ensures portability of that data, will protect the digital twin information even if a right to be forgotten is executed towards a specific SP.

What is therefore needed is a system and method to correct the aforementioned inadequacies.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a prior art architecture showing the inadequacies of existing service provider/customer models;

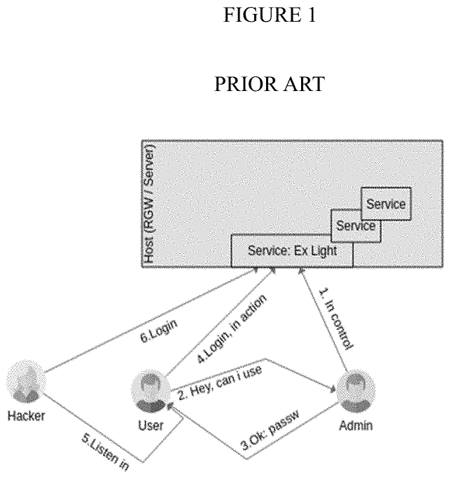

FIG. 2 is a diagram illustrating the overall architecture of the system and methods in accordance with an embodiment of the present disclosure;

FIG. 3A is a diagram illustrating the various layers of a smart family realization model in accordance with an embodiment of the present disclosure;

FIG. 3B is a diagram illustrating device and user association flow, the diagram including different entities such as a service portal, user devices a capability and rule databases in accordance with an exemplary embodiment of the present disclosure;

FIG. 4 is a diagram illustrating the sequence flow between a user, a SP and a vendor, in order to register the SP and create a user hub in accordance with an embodiment of the present disclosure;

FIG. 5 is a diagram illustrating the sequence flow between a first SP and a second SP, including various interior services, in order to combine or enhance capabilities in accordance with an embodiment of the present disclosure;

FIG. 6 is a diagram illustrating the sequence flow for registration of user content in accordance with an embodiment of the present disclosure;

FIG. 7A is a diagram showing an apparatus for anonymization and cross delegation of consumption rights between users in accordance with an embodiment of the present disclosure;

FIG. 7B depicts a flowchart of a method performed by a user device or a computing device according to some embodiments herein;

FIG. 8 is a diagram illustrating the sequence flow for providing consent-based access to service catalogs in accordance with an embodiment of the present disclosure;

FIG. 9 is a diagram illustrating the sequence flow for securing availability and user ownership of data repositories independent of service providers in accordance with an embodiment of the present disclosure;

FIG. 10A is a diagram illustrating the sequence flow for revocation of services in compliance with GDPR standards and the automatic deletion of services and relations in accordance with an embodiment of the present disclosure.

FIG. 10B depicts a flowchart of a method performed by a user device or a computing device according to some embodiments herein; and

FIG. 11 is a block diagram of an exemplary computing device that may be incorporated into any of the components discussed in the present disclosure.

### DETAILED DESCRIPTION

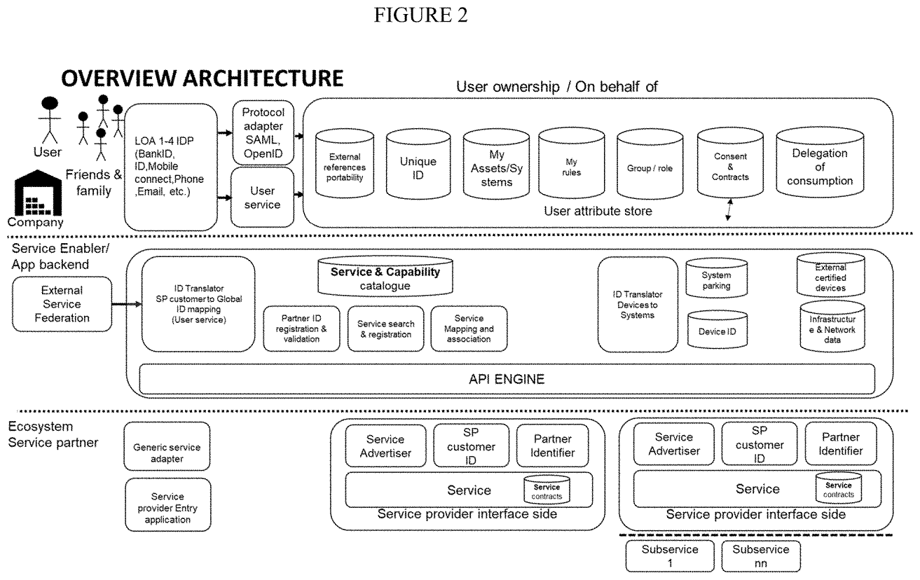

Referring to FIG. 2, an overall architecture of the system of the present disclosure is shown.

### Root Identity Handling

Identities are derived from sources with appropriate Level of Assurance (LOA) levels. Only true root identities like national ID can be referred to for authentication of personal data. ID-exchange is carried out to a global ID for the ecosystem. This becomes the common denominator of associations, because pure IDs cannot carry attributes properly. Other ecosystems may exist and have to be interconnected through the translator to maintain integrity (user always decides what data is shared).

### User Ownership Layer

Referring again to FIG. 2, the User Ownership Layer ensures portability of data ownership, includes the legal framework alignment (GDPR etc.), stores attributes and assets and includes systems consisting of combined assets (e.g., items in a house). The Unique ID module is a globally unique user-ID based on root IDs, and is capable of handling consented user attribute distribution inside an ecosystem. The My Rules module contains mandatory logic for services to act upon. The Group/Role module maintains a list of memberships, where the personal group is created as mandatory where a user can belong to several groups. The Delegation of Consumption module tracks all delegated rights for consumption in a group.

### Service Enabling Engine

The Service Enabling Engine portion, and its components, as shown in FIG. 2, will now be discussed. The ID Translator module ensures integrity and anonymization of a customer's ID from a service provider. The Service Catalogue keeps all registered capabilities and is accessible from a set of services with access consent control from the user. The Partner ID keeps track of certified SP relations. The Service Identifier service (Service search and registration) allows SPs to register and read other SPs' capabilities (user consented). The Service Mapper creates linking through tokens/certificates between SPs, but is always revocable through user consent.

Infrastructure data such as position, etc., is available for enrichments, still according to the user's terms. Devices are handled separately, through a similar mergepoint in the service enabler. This function needs to support parking of systems/devices in transit (i.e., change of ownership). External certified devices keeps track of externally certified devices (e.g., medical equipment).

### Service Provider Interfaces

Referring again to FIG. 2, Service Providers (SPs) will now be defined and discussed. As the term is used herein, an SP can exist in three different types. Type 1—a normal SP with full Application Programming Interface (API) integration. Type 2—a normal SP with full API integration and registered subservices. Type 3—a virtual SP created as a passive responder or service adapter. An SP registers its capabilities in the service catalogue in dialogue with its customer (always part of or becoming part of an ecosystem as true user.) An SP is capable of reading associated capabilities from other SPs upon user consent. An SP can initiate an association request. A Type 3 adapter opens up for service creation in places where SPs do not exist for various reasons or where a user wants to have custom services.

A Type 2 SP has additional subservice capabilities available. A subservice is a container for other SPs' capability engines. The subservice is related to the SP. A typical application can be, for example, a gateway Consumer Premises based Equipment (CPE) unit for Internet access in a household that can run containerized logics for another vendor to supply home alarm or smart home services. Agreements are created between SPs with user consent through the service catalogue.

An example of a Type 3 SP is, for example, a food supplier webshop that can create its own “smart fridge” before vendors exist on the market. The service adaptor could be named, for example, “generic fridge” and its functions could be manually entered through an app built by the food supplier called, for example, “fridge inventory.” The food supplier can consume this information through the API layer (service catalogue) and thereby open up for handover to a real vendor of fridges (open API policy). The service adaptor can also be used as a custom built component to enable innovation.

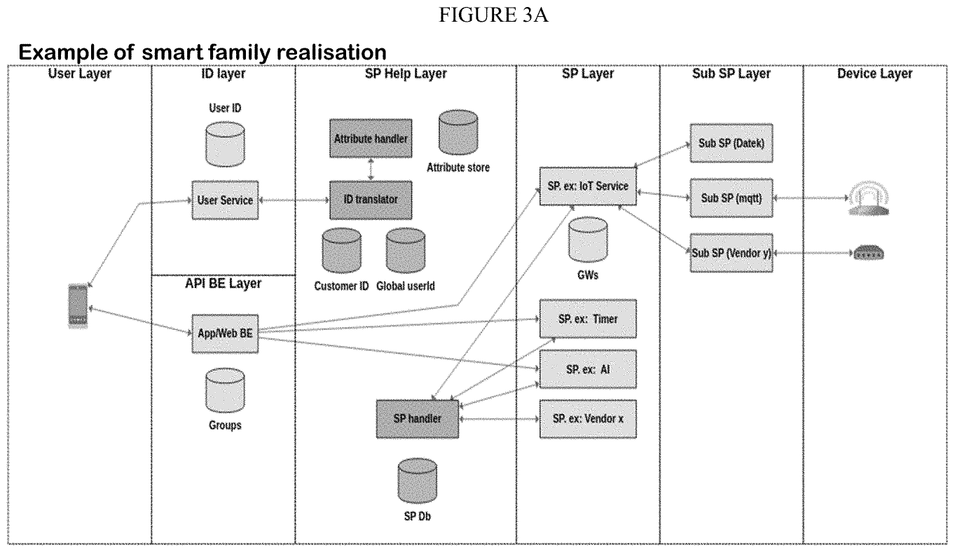

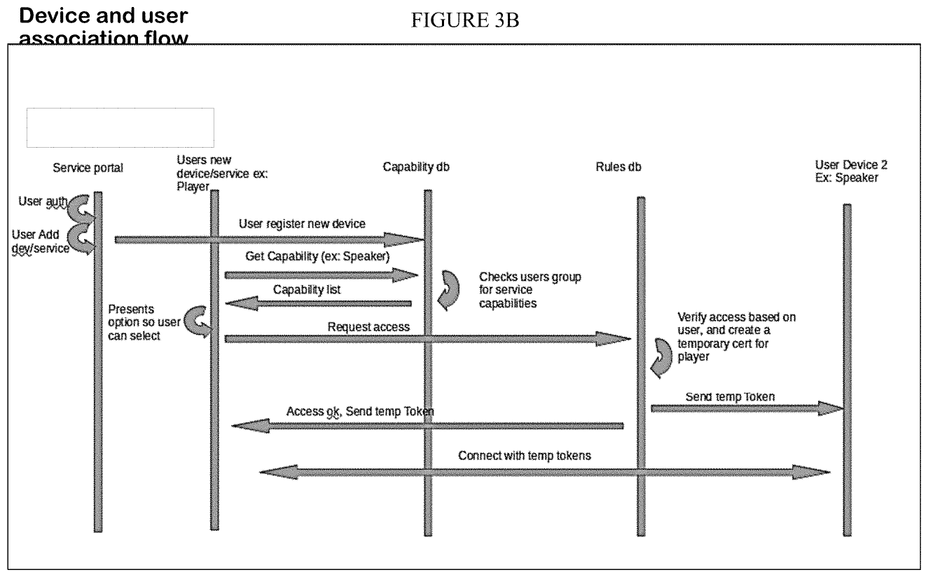

FIG. 3A is a diagram illustrating the various layers of a smart family realization model in accordance with an embodiment of the present disclosure. The various layers include a User Layer, an ID layer, an SP Help Layer, an SP Layer, a Sub SP Layer and a Device Layer.

### Embodiment 1

In one embodiment of the present disclosure, a method and system for human-to-device collaboration through digital hub and spoke contracts between SPs with user consent is provided. In accordance to one aspect of this embodiment, an apparatus for registration of capabilities surrounding a service is provided, where the data owner can include a consent for data exchange and control between services related to the contract. A user with a customer contract to a SP can have its specific capabilities detailed in the capability database.

In this example, a user enters the hub for the first time and searches the SP registered ecosystem. The user decides to become customer with a selected set of SPs. The specific selected capabilities for each service are registered in the service and capability catalogue. The right to use is controlled by consent data and contract database. SPs can build new combined services on insights from contracted and shared capabilities. This “SP enrichment” method shall be described in further detail later in this disclosure. In one aspect of this embodiment, prerequisites include services that are able to register capabilities in a common repository, SPs that are already accepted as an ecosystem partner, the data owner has consent control, and the user has an acceptable identification method.

In this embodiment, a certificate/token is shared per capability (for example a capability might be for lights but not the fire alarm in a home automation system). Consent might be issued to control communication between services or devices with an always active revocation ability by user. Access control might be through the token/certificate or other connection using various service buses. The user is always in control through contract, consent, or a “wish and will” list. The ability to scan a user is restricted by consent and published capabilities are always controlled by the user.

The following is a non-limiting example of an application of this embodiment. Initially, an identified user registers on the hub for the first time and receive a global ID. A personal group is mandatory and is created automatically by the system with full ownership of user (e.g., same name as the user). The user then searches for registered SPs in the ecosystem. Any previously registered SPs will be displayed with their capabilities. If a user already has an existing relationship with a SP in the ecosystem, ID mapping with global ID is performed and the user's already contracted capabilities will be available.

The SP then exposes capabilities for its service, independent of the user's (data owner's) final selection. The user will see actual and optionally available capabilities in one view. The user selects a SP for contractual agreement or simulation. In case of a contract, the user is redirected to the customer page at the SP. Relevant user attributes like address, etc., are transferred upon user consent (this prohibits data mining). A dialogue is maintained through the SP API towards the hub to build necessary relations (i.e., tokens/certificates). The SP will be given access to the global ID and will use that to register user capabilities in the Service and Capability catalogue. Publishing for ecosystem search is upon user consent. Contracts are registered in the user's contracts & consent databases and in respective SP databases.

FIG. 3B is non-limiting example of an application of the previously described embodiment. The diagram illustrates device and user association flow, the diagram including different entities such as a service portal, user devices a capability and rule databases. As shown, when a access request is sent from a user device, the access is verifies and a temporary certificate/token may be creates, which certificate/token is subsequently sent to another user device enabling user devices to connect using the certificate/tokens. The flow of FIG. 3B is self-explanatory.

### Embodiment 2

In another embodiment of the present disclosure, a method and system for onboarding SPs and their customers to an open hub is provided. In accordance with one aspect of this embodiment, an apparatus for registration of a SP in an ecosystem and also the registration and transfer of an SP customer into a global ID is provided. In one aspect of this embodiment, prerequisites require that the SP is qualified according to quality and compliance standards and the SP has the technical capabilities to connect to the ecosystem.

In this embodiment, an SP is offered connectivity to the ecosystem (hub) through an API. The SP customer base can be offered to the ecosystem and registration as users with its own hub through the hub API. The SP always retains the customer relationship. Registration of an SP includes acceptance of compliance and technical capabilities as well as commercial requirements. An SP can exist both as a commercial and non-commercial actor.

Registration contains two different processes: (1) SP registration with secure ID and related services with general capabilities; and (2) SP customer ID to Global user ID translation. The SP itself will have to register with a valid trusted ID (e.g., trusted person, firmatecknare). The second stage appears when the SP customer wants to connect to the ecosystem for the first time. In this stage, the customer ID of the SP will be mapped to the Global user ID and the user will be registered with a personal hub and availability of global service provider search.

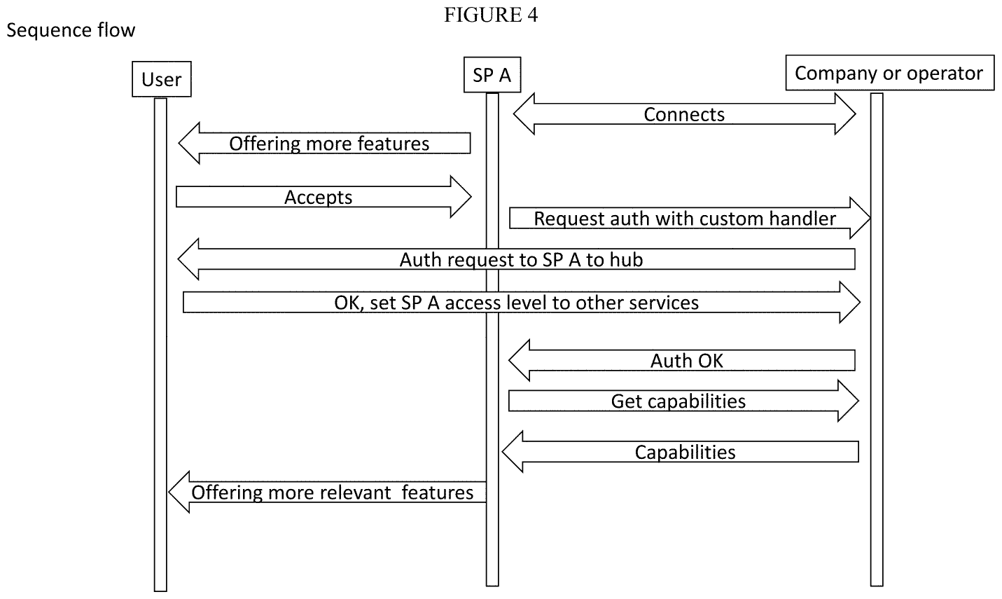

In conjunction with FIG. 4, the following is a non-limiting example of an application of this embodiment. The SP gets its SP ID through a validation process for various compliance parameters. The SP registers its service offerings and related capabilities in the services & capabilities catalogue. The SP User is addressed through the SP user interface, requesting ecosystem association. The SP requests a user customer to Global user id translation towards the ecosystem API. The ecosystem back checks the user ID at, for example, Eidas high, LOA3, or a similar level before adding a new Global user ID. Only known IDs are accepted (anonymity still exists between services but not inside the trust domain).

Next, consent for creating a user hub is requested from the user. At least one group is created automatically by the system with full ownership of the user (e.g., same name as the user). Already contracted capabilities are associated with the group. A consent request from the SP is then sent to the user to allow a search for other capabilities. If this is OK, the SP will run a search for known integrated capabilities and store new combinations.

### Embodiment 3

In another embodiment of the present disclosure, a method and system for user-consented cross search between SPs for capabilities that might enrich their combined offering or functionality is provided. Initially, each SP has to request rights to scan the user's SP association list. SPs then evaluate new possible combinations, where new combined capabilities may occur. New capabilities are registered the same way as a non-combined capability. New combinations are classified as mutual or non-mutual SP offerings. New combinations are also detected and published by ecosystem processes. New offerings can be advertised to the user through the SP UI.

Each associated SP requests rights to scan the user's SP associations. SPs evaluate new possible combinations, where new combined capabilities may occur. New capabilities are registered the same way as a non-combined capabilities. A background process in the hub detects changes independently and advertises towards the user in a suitable way with the purpose of highlighting ongoing activities. New offerings are created by an SP or SPs and advertised to the user through the SP's UI to maintain an existing customer relationship. A new independent offering can be created by a new SP entering the hub. This offering might well be a business insight about one or several other SPs provided that data is available and not locked by other commercial agreements. Transfer of data fees might also appear.

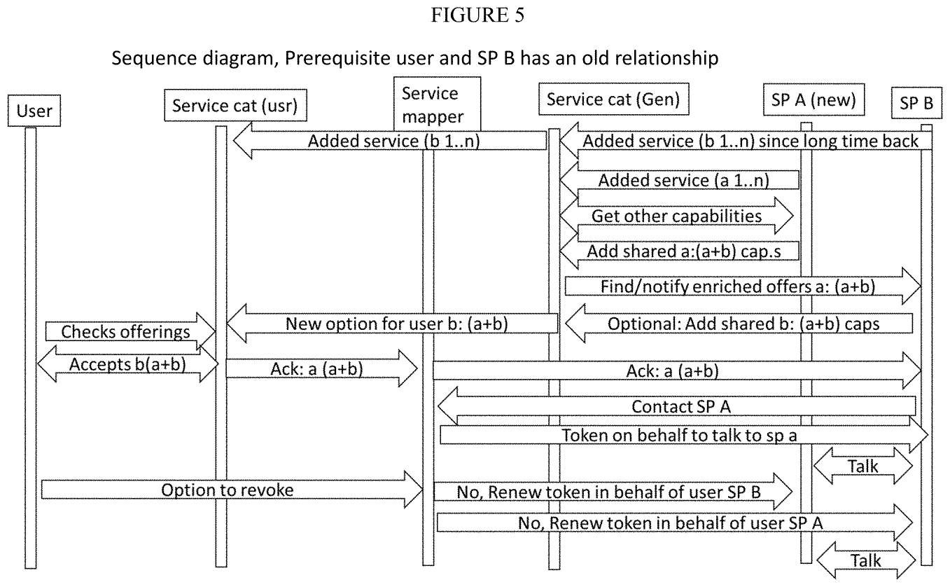

In conjunction with FIG. 5, the following is a non-limiting example of an application of this embodiment. SPs participating outside or inside a user's domain read and calculate possible common capabilities (new capabilities might appear). Outside domain scanning may have less detail than inside domain scanning due to lack of consent. The user is always in control of visibility by consent (e.g., the ability to hide two competitors from each other). Each SP creates its new offering towards the user. A combined service could be compared to a black list and eventually blocked.

An offering is created, and the user selects the new service. The user (data owner) consents to what services and data should be available to share and tokens are delivered. A second SP (SP2) then makes a request for services from the capability database. If consent from the user is received and accepted, possible capabilities will be transferred. SP2 then requests association with possible capabilities of the other SP. If the user consents to this association, a token will be transferred for the specific capability. A “decline” can either be generated by the user, or be caused by a non-existing capability. Connection is established and dependant on Time To Live (TTL) on a token/cert or revocation from user.

### Embodiment 4

In another embodiment of the present disclosure, a method and system for user consent in a database built on technologies that ensures future distribution without sacrificing the ownership of the user's data is provided. Every process of the user data has to be accepted by the user transferring a service unique and revocable token/certificate. In one aspect, in maintaining consent with user owned data, revocation is possible, and a digital twin can act on behalf of the user without restricting, i.e., “locking” this function to a specific vendor. The token/certificate is stored in a way that revocation may be possible instantly. This means, a user can stop a service from running or data to be shared at any time without needing to go into specific vendor processes. In one aspect, prerequisites include services are available in need of processing user data and user interaction or a digital twin function responds to SP-requests.

An abstraction exists to ensure a neutral interaction point, where the user's consent and other control parameters are stored in a standardized and secure way. This layer can exist on a specific hub provider or in a future distributed ledger solution. In both cases, the data has to be portable in an open way owned by the user alone, not as a customer. After consent, revocable tokens/certificates are sent to every created and agreed capability from each SP or between SPs. Each consent includes variables controlling TTL in order to avoid unnecessary traffic to the hub. In general, all traffic exchange between services and service providers are direct as long as a valid a token/certificate exists.

Because the user is involved in every issued token/certificate, a revocation is possible at any time, even if the token/certificate is issued between two SPs. Selection of a token/certificate is done based on online or offline requirements. Tokens/certificates can be one-time, based on the amount of times used, time-limited, or can have offline capability. The only situation that does not have immediate revocation capability is the offline case, where it might not be possible to check for validity at a certain time. In general, tokens are suitable for online behavior and certificates are suitable for offline use.

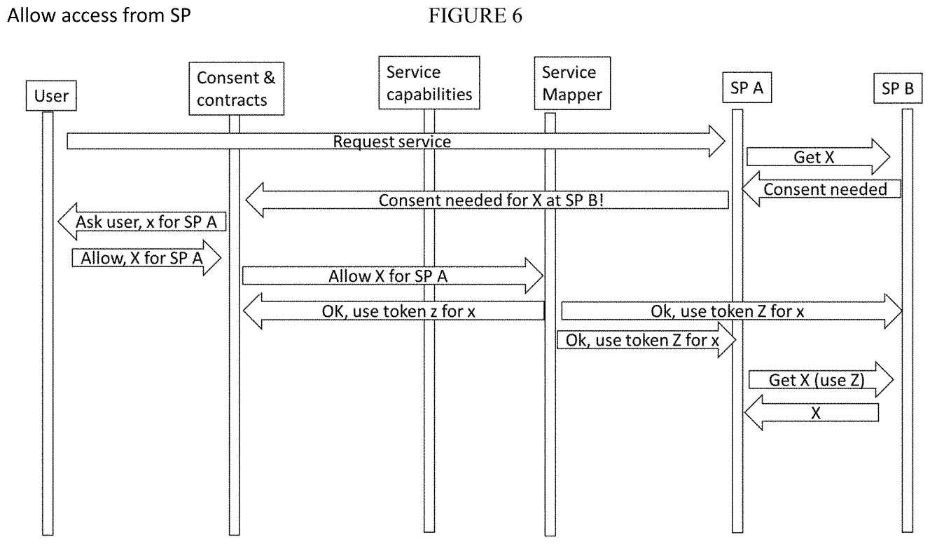

In conjunction with FIG. 6, the following is a non-limiting example of an application of this embodiment. The user initiates some kind of interaction with one of the SPs. The SP requests from the user the right read capabilities or specific user data. The association hub relays the call through the API layer to the user or its digital twin. The user or its digital twin responds with an accept or a deny for the specific request by issuing an appropriate token/certificate. An acceptance will be followed by a set of attributes covering TTL, inheritance rights and usage type. The certificate can be one of several types covering user-to-user access, device-to-user, device-to-device or SP-to-SP communication. The requesting SP then inserts the token/certificate in the appropriate flow and the function is activated.

### Embodiment 5

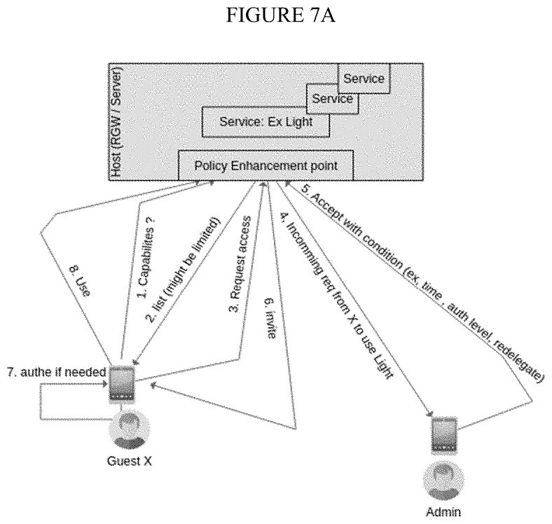

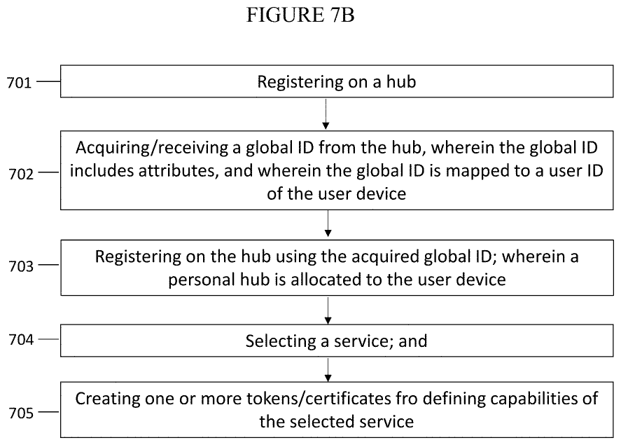

In conjunction with FIG. 7A, in another embodiment of the present disclosure, a method and system for anonymization and cross-delegation of consumption rights between users, services and data, is provided. A user is protected from misuse of identities by using real verified identities for each delegation. SPs' customer information is protected from leakage by translating customer IDs to common global IDs. This ID is used across SPs and in all handling of user data. The user global ID is always verified towards a high trust true ID. The global ID is capable of carrying attributes in addition to pure ID information. Attributes might be, for example, consents, rules, and/or delegations, etc. The global ID will be hub dependent, but federations are possible between hubs, thus maintaining an open environment. SPs' customer relations are never touched by the hub. Instead user interaction is preferred through SP relations.

Each new user in the hub will always have a first group automatically assigned. This group is stored with the global ID. A user can own and belong to multiple groups. A user owning or belonging to a group can inherit rights and services within that group, provided that the specific token/certificate allows for this. Revocation is always possible. Delegation of consumption rights could be transferred through inheritance in several steps if the token/certificate allows for this.

A typical and non-limiting user interaction scheme for this embodiment is as follows. (a) create a first group (always the same as the owner); (b) create an add-on group to delegate: (c) create levels or classes (attribute controls like adult/child/class); (d) provide service capability filtering for consumer view; (e) invite users on behalf of administration or service consumers; (f) receive user request for consumption; (g) delete user; and (h) delete delegations.

The following is a non-limiting example of an application of this embodiment. In this example, a connected homeowner can share his/her control over services with a guest or family member. The homeowner has his/her services connected to a group called “home.” The homeowner invites a new user (consumer of services) to his/her group. The homeowner decides which services to share and allows inheritance of consumption rights to the selected user, with or without continued inheritance. The selected user receives an invitation to the group and accepts by making an appropriate identification. The selected user can now browse and add/consume available capabilities and assets in the homegroup. An SP can have knowledge of the new group member through the global ID, but can only have a customer relationship with the homeowner (group). Everyone else will use global IDs and consumption will happen on behalf of the homeowner. The selected user may add its own services for consumption by others in the same group. A revocation of rights can be done by anyone in the delegation chain, cutting all inheritance below that user.

In conjunction with FIG. 7B, there is illustrated some steps of a method performed by a user device or a computing device according to some embodiments previously described.

As shown, the method comprises:

(701) registering on a hub in a system;

(702) acquiring/receiving a global identity (ID) from the hub, wherein the global ID includes attributes, and wherein the global ID is mapped to a user ID of the user device;

(703) registering on the hub using the acquired global ID; wherein a personal hub is allocated to the user device;

(704) selecting a service; and

(705) creating one or more tokens/certificates for defining capabilities of the selected service.

As previously explained, the method also comprising storing the one or more tokens/certificates in a (capability) database, wherein the token(s)/certificates are revocable by the user of the user device. The method also comprising requesting and consenting to what type of services or data are available for sharing and wherein each service is associated with a token/certificate. Each of the tokens/certifications are dependent on a TTL value. The method also comprising inviting a new user to the user's allocated personal hub and deciding which services to share and allowing inheritance of consumption rights to the invited user.

There is also provided a method performed in a system comprising one or more hubs, one or more service providers (SPs) and one or more user devices, according to some previously described embodiments. the method comprising: the one or more hubs requesting association or connection to one or more SPs; the one or more SPs accepting the request for association or connection to the one or more hubs; the one or more SPs registering each to the one or more hubs with a valid service provider ID; each of said one or more service providers acquiring one or more tokens/certificates, after consent from a user device and further get access to a global ID of the user device; and the one or more SPs requesting from the user device the right to read capabilities or specific user data. Each of the one or more SPs exposing or sharing its capabilities for its service, independently of the user's selection; and the one or more SPs use the global ID of the user to register user capabilities in a service and capability catalogue. Each of the SPs scanning the user's SP associations. if consent from the user is received and accepted by one or more SPs, the one or more SPs request association with capabilities of other SPs, and if the user consents to the association, at least one token/certificate is transferred for at least one capability to a service selected by the user. A system comprising one or more hubs, one or more service providers and one or more user devices, is also provided to perform the method steps disclosed above.

### Embodiment 6

In another embodiment of the present disclosure, a method and system for registration of user preferences to minimize complexity on consent decisions, is provided. This embodiment provides the ability to automate consent handling by using digital twin concepts to mirror a user's “will and wish” by creating abstraction of the user from the customer. The embodiment includes pre-seeding of requisites for SPs to act upon (certified SP services). A certified hub service is a SP capability that has been pretested and validated. A three step process can be created, where: (1) SPs can see each other if registered to the hub, but not browse users; (2) SPs can see a user's contracted SPs upon consent; and (3) SPs can see a user's contracted SP capabilities on extended consent. This creates a possibility to devise new combined capabilities and also offer them in a process where an SP is not always capable of finding out what a competitor might be already using already Cross-creation of new services opens allows for innovation. The user will have one single point of control to deny usage for all services.

In one aspect of this embodiment, prerequisites include services that are capable of reading the register of user prerequisites (“will and wish”), the ability to detect conditional actions, and the SP is registered and accepted by the hub and, at a second stage, by the user.

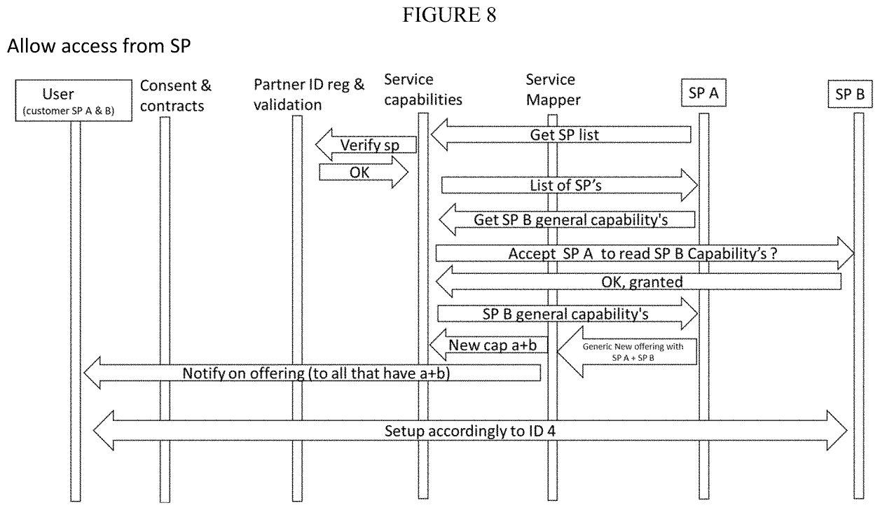

In conjunction with FIG. 8, the following is a non-limiting example of an application of this embodiment. A user builds its own “will and wish” list based on static requirements and/or insights taken from AI recording of dynamic behavior. The user is exposed to various options based on the above setup. Decisions are made by user on acceptable levels of interaction. The user registry is exposed to contracted service providers (through user domain definition) and the user defines visibility beyond SPs seeing each other in the hub. SPs adopt services based on the user's “will and wish” list. Any changes to the user's will and wish list will automatically update SP capability maps. Changes in SP services will automatically require a new consent (could be automated or manual depending on user preferences).

### Embodiment 7

In another embodiment of the present disclosure, a method and system for automating decisions based on a user's will and wish list, is provided. Automation is needed to achieve simple user interaction in complex systems. This will require “wish and will” contexts for users as well as “my rules” and legal alignment checks. All this has to be presented to the user showing possible consequences with simulation tools since nobody will have the capability to understand all components in a complex service. The man-machine interface has to be as simple as Boolean expressions and data has to be formatted accordingly.

“Wish and will” lists are the simplified explanation of text and graphics where a user can determine this. In the end, an AI machine will be able to interact and improve this list, the difference being that the user stills owns the rules and the machine does not store the insights at a vendor or SP location but at the user's repository in an open format. Over time, this understanding will be universal and understandable by several AI functions implemented as SP capabilities. Simultaneous use of AI machines from several vendors is possible this way, each with specific targeted tasks. Determined wish and will statements require consent by the user and then user owned as a twin.

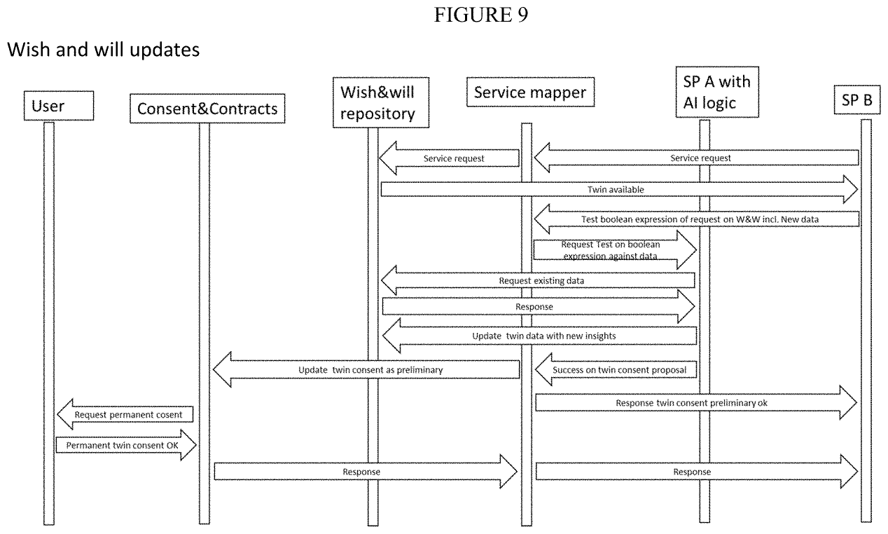

In conjunction with FIG. 9, the following is a non-limiting example of an application of this embodiment. A user repository is associated with a global ID, where a list of logical expressions is stored to describe the users “wish and will.” The “wish and will” data may be used in two channels. One channel is back-checking compliance of SPs in the ecosystem and the other (described below) is the interaction to support good behavior from SPs (on the user's terms). A digital twin logic capability can be built as a freestanding SP or as part of an existing SP. A common denominator is that logical expressions and insights about the user that defines the user are stored in a separate user repository in the association hub portion that belongs to the user. Several AI SPs can coexist with different skills, but they have no exclusivity to data beyond their customer contract with their customer.

### Embodiment 8

In another embodiment of the present disclosure, a method and system for revocation of services with compliance to GDPR (right to be forgotten) including automatic deletion of services and relations, is provided. An apparatus for maintaining a link between central user consents and tokens/certificates shared between services and/or devices directly is provided. This solution allows immediate revocation and full user control including chained delegated rights and SP-to-SP tokens and also allows for automated deletion of services and data. The abstraction of consent from the SP makes it possible to store profiling data at the user repository instead. This preserves attributes even if rights to be forgotten have been executed at the SP level. A new SP can interpret the user's intended “wish and will” logic by reading the old consent.

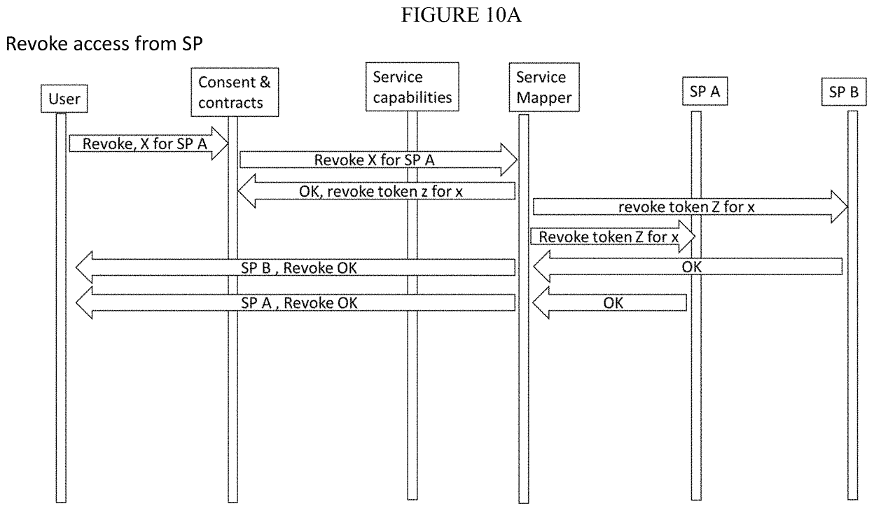

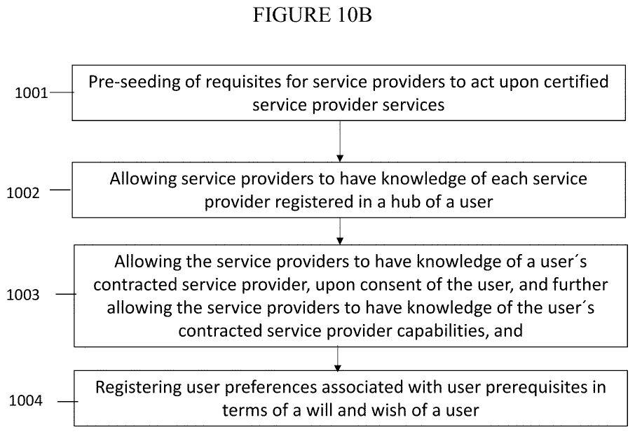

In conjunction with FIG. 10A, the following is a non-limiting example of an application of this embodiment. A user is able to view manually and/or automatically generate delegated rights (e.g., top ten analysis of frequent actors). The user can request the consequences that may occur upon deletion from involved parties (SPs). The user can simulate deletion in advance and then permanently delete tokens/certificates. Original consent is also stored in the user repository after revocation, but without the link to token/certificate data. This can be reused for another SP onboarding, as it is possible to understand the user-intended logic to a certain extent. Some of this data is also essential for wish and will expressions. Revoked service association (termination of service) will erase services and data across all involved parties (“right to be forgotten”) except for the users own repository.

In conjunction with FIG. 10B, there is illustrated some steps of a method for registration of user preferences performed by a computing device according to some embodiments previously described.

As shown, the method comprises:

(1001) pre-seeding of requisites for service providers to act upon certified service provider services;

(1002) allowing service providers to have knowledge of each service provider registered in a hub of a user;

(1003) allowing the service providers to have knowledge of a user's contracted service provider, upon consent of the user, and further allowing the service providers to have knowledge of the user's contracted service provider capabilities; and

(1004) registering user preferences associated with user prerequisites in terms of a will and wish of a user.

As previously described, the method further comprises, each service provider adopting its services based on the user's prerequisites in terms of said will and wish list. Further any change to the user's will and wish list automatically requires a new consent from the user. Consent handling of a user is automated using at least one digital twin to mirror the user's prerequisites in terms of said will and wish of the user. The method further comprising, storing the prerequisites in terms of the wish and will of the user in a user repository, wherein the user repository is associated with a global ID. The digital twin is created in a freestanding service provider or as part of an existing service provider.

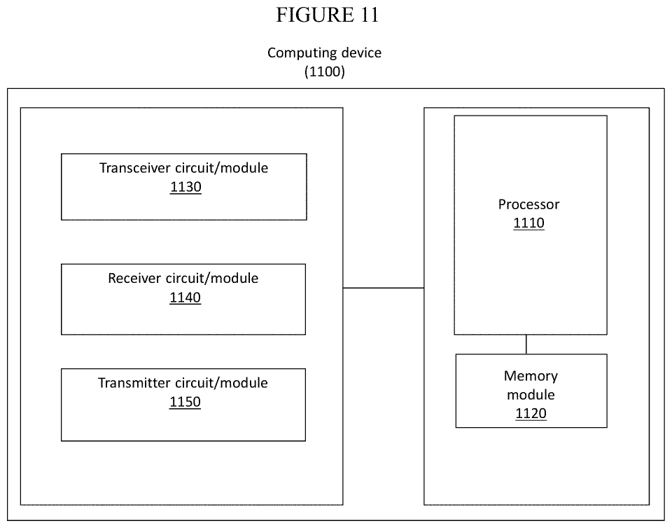

FIG. 11 is a block diagram of an exemplary computing device that may be incorporated into any of the components discussed in the present disclosure. The computing device comprises processing circuitry or a processing module or a processor; a memory module; a receiver circuit or receiver module; a transmitter circuit or a transmitter module and a transceiver circuit or a transceiver module which may include transmitter circuit and receiver circuit. The processing circuitry may include and/or be connected to and/or be configured for accessing (e.g., reading from and/or writing to) the memory module. The memory module may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory).

The memory module may be configured to store code executable by control circuitry and/or other data, e.g., data pertaining to communication, e.g., configuration and/or address data of nodes, etc. The processing circuitry may be configured to control any of the methods described herein and/or to cause such methods to be performed, e.g., by the processor. Corresponding instructions may be stored in the memory module, which may be readable and/or readably connected to the processing circuitry. In some examples, the processing circuitry may include a controller, which may comprise a microprocessor and/or microcontroller and/or FPGA (Field-Programmable Gate Array) device and/or ASIC (Application Specific Integrated Circuit) device. It may be considered that the processing circuitry includes or may be connected or connectable to the memory module, which may be configured to be accessible for reading and/or writing by the controller and/or processing circuitry. The computing device may include additional components not depicted in FIG. 11.

According to some of the embodiments previously described, the computing device is configured to register on a hub in a system; acquire/receive a global ID from the hub, wherein the global ID includes attributes, and wherein the global ID is mapped to a user ID of the computing device; register on the hub using the acquired global ID; wherein a personal hub is allocated to the computing device; select a service; and creating one or more tokens/certificates for defining capabilities of the selected service. The computing device further is configured to store the one or more tokens/certificates in a database, wherein said one or more tokens/certificates are revocable by the user of the computing device. The computing device is configured to request and consent to what type of services or data are available for sharing, wherein each service is associated with a token/certificate. The computing device is also configured to invite a new user or user device to the user's personal hub, to decide which services to share and to allow inheritance of consumption rights to the invited user device.

According to some other embodiments previously described, the computing device is configured or operated to pre-seed of requisites for service providers to act upon certified service provider services; allow service providers to have knowledge of each service provider registered in a hub of a user; allow the service providers to have knowledge of a user's contracted service provider, upon consent of the user, and further allow the service providers to have knowledge of the user's contracted service provider capabilities; and register user preferences associated with user prerequisites in terms of a will and wish of a user.

The computing device is configured to adopt for each service provider, the service provider's services based on the user's prerequisites in terms of said will and wish list. Any change to the user's will and wish list automatically require a new consent from the user. Consent handling of a user is automated using at least one digital twin to mirror the user's prerequisites in terms of said will and wish of the user. The computing device is further configured to store the user repository in a hub, or in a portion of the hub, belonging to the user. The digital twin is created in a freestanding service provider or as part of an existing service provider. The computing device is further configured to delete the user's prerequisites in terms of the will or wish of the user, upon receiving a request from the user.

Throughout this disclosure, the word “comprise” or “comprising” has been used in a non-limiting sense, i.e., meaning “consist at least of.” Although specific terms may be employed herein, they are used in a generic and descriptive sense only and not for purposes of limitation.

The present disclosure can be realized in hardware, software, or a combination of hardware and software. Any kind of computing system, or other apparatus adapted for carrying out the methods described herein, is suited to perform the functions described herein.

A typical combination of hardware and software could be a specialized computer system having one or more processing elements and a computer program stored on a storage medium that, when loaded and executed, controls the computer system such that it carries out the methods described herein. The present disclosure can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

It will be appreciated by persons skilled in the art that the invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

### GENERAL DEFINITIONS

Party Management (PM)—the relation between groups of humans, devices and services. Party Management is also referred to as Relation Management. The principles for PM are in line with the basis and principles of national law to be relevant. Different kinds of restrictions and prohibitions, e.g., underage, have to be handled in a compliance with national legislation.
Person a physical (human) or legal entity (e.g., company, organization).
User—a physical or legal Person.
Service Provider (SP)—a legal entity offering services to Users.
Consumer—a user or device consuming either its own or delegated services within a group.
   A Customer is a User who has a paying relationship with one or several Service Providers.
Device—self-contained hardware with embedded software that can be everything from a single sensor with the ability to offer one capability to a very competent system able to offer many capabilities to an external party.
Capability is a benefit presented to other Users, Devices or Services.
System—consists of different connected Capabilities were at least two are separately addressable.
Service—a piece of self-contained software able to offer capabilities to an external party.
Users ID—all attributes that together describes a Person. In the present disclosure, a True User ID (also called Root ID) is the identity registered by a national authority or a corporation appointed by a national authority. Attributes could be attached to a User ID. A True User ID could be translated to another User ID representing the same User.
Level Of Assurance (LOA)—defines the security level of a User ID.
Global User ID—a translation of a User ID.
Ecosystem—a network of organizations—including but not limited to suppliers, distributors, customers, competitors, government agencies, etc., involved in the delivery of a specific product or service through both competition and cooperation.
GDPR—regulation in EU law on data protection and privacy.
CPE—Customer Premises placed Equipment.
API—Application Programming Interface.
Hub—a System Device with certain capabilities.

### GROUP DEFINITIONS

A group can consist of a combination of Users, Devices and Services. A group consists of at least of one member. There is always one Owner of a group. The Owner of a group is always a Person (human or legal). The ownership of a group can be transferred from one User to another User. When a User is registered for the first time in the “Hub,” a new group is always formed with the User as Owner. This is called the User Personal Group. An Owner can invite another User, a Device or a Service as member in the group. The right to invite members to a group can be delegated from the Owner to a group member. The User or the Owner of a Device or a Service must give consent to participate as a group member. Users, Devices and Services can be members of different groups at the same time. The invitation to a group can be permanent or temporary. The membership can be revoked at any time. Membership rights in a group are delegated separately per User, Device or Service. An example could be the right to read, change, buy and the right to invite new members. Membership rights can be one time based, time scheduled or permanent and can be changed at any time during a group membership.

1-20. (canceled)

21. A method performed by a user device or a computing device having a contract with a service provider (SP), the method comprising:
registering a user of the user device on a hub in a system, wherein the hub is a system device with capabilities;
acquiring/receiving a global identity (ID) from the hub, wherein the global ID includes attributes, and wherein the global ID is mapped to a user ID of the user device, wherein said attributes include at least consents of the user, wherein the user consents to what services and data should be available to share;
sending said consents to the service provider;
registering on the hub using the acquired global ID, a personal hub being allocated to the user device by the hub; wherein the personal hub is used by the user to invite new users to the user's personal hub, to decide which services to share to allow inheritance of consumption rights to an invited user;
selecting a service; and
creating one or more tokens/certificates for defining capabilities of the selected service; wherein said one or more tokens/certificates is/are provided to the service provider.

22. The method according to claim 21, further comprising storing the one or more tokens/certificates in a database, wherein said one or more tokens/certificates are revocable by a user of the user device.

23. The method according to claim 21, further comprising requesting and consenting to what type of services or data is available for sharing and wherein each service is associated with a token/certificate.

24. The method according to claim 21, wherein each one of the one or more tokens/certificates is dependent on a Time To Live (TTL) value.

25. The method according to claim 23, further comprising inviting a new user to the user's personal hub, deciding which services to share, and allowing inheritance of consumption rights to the invited user.

26. A method in a system comprising one or more hubs, one or more service providers and one or more user devices; wherein a hub is a system device with capabilities, the method comprising:
the one or more hubs requesting association or connection to one or more service providers;
the one or more service providers accepting the request for association or connection to the one or more hubs;
the one or more service providers registering each to the one or more hubs with a valid service provider ID;
each of said one or more service providers acquiring, from a user device, one or more tokens/certificates, after consent from the user device and further getting access to a global ID of the user device; wherein the global ID includes attributes, wherein said attributes include at least consents of the user; wherein the user consents to what services and data should be available to share;
each of said one or more service providers receiving said consents from the user; and
the one or more service providers requesting from the user device the right to read capabilities or specific user data.

27. The method according to claim 26, further comprising each of the one or more service providers exposing or sharing its capabilities for its service, independently of the user's selection; and the one or more service providers using the global ID of the user to register user capabilities in a service and capability catalogue.

28. The method according to claim 26, further comprising each of said one or more service providers scanning the user's service provider associations.

29. The method according to claim 28, wherein if consent from the user is received and accepted by one or more service providers, further comprising the one or more service providers requesting association with capabilities of other service providers.

30. The method according to claim 29, wherein if the user consents to the association, at least one token/certificate is transferred for at least one capability to a service selected by the user.

31. A computing device of a user having a contract with a service provider (SP), the computing device comprising processing circuitry; a memory module; a receiver circuit; a transmitter circuit, the memory module containing instructions executable by the processing circuitry, wherein the computing device is configured to:
register a user of the user device on a hub in a system, wherein the hub is a system device with capabilities;
acquire/receive a global identity (ID) from the hub, the global ID including attributes, the global ID being mapped to a user ID of the computing device, wherein said attributes include at least consents of the user; wherein the user consents to what services and data should be available to share;
send said consents to the service provider;
register on the hub using the acquired global ID, a personal hub being allocated to the computing device by the hub, wherein the personal hub is used by the user to invite new users to the user's personal hub, to decide which services to share to allow inheritance of consumption rights to an invited user;
select a service; and
create one or more tokens/certificates for defining capabilities of the selected service; wherein said one or more tokens/certificates is/are provided to the service provider.

32. The computing device according to claim 31, further configured to store the one or more tokens/certificates in a database, wherein said one or more tokens/certificates are revocable by the user of the computing device.

33. The computing device according to claim 31, further configured to request and consent to what type of services or data are available for sharing and wherein each service is associated with a token/certificate.

34. The computing device according to claim 31, wherein each one of the one or more tokens/certificates is dependent on a Time To Live (TTL) value.

35. The computing device according to claim 33, further configured to invite a new user or user device to the user's personal hub to decide which services to share and to allow inheritance of consumption rights to the invited user device.

36. A system comprising one or more hubs, one or more service providers and one or more user devices, wherein a hub is a system device with capabilities, the system comprising:
the one or more hubs configured to request association or connection to one or more service providers;
the one or more service providers configured to accept the request for association or connection to the one or more hubs;
the one or more service providers configured to register to the one or more hubs with a valid service provider ID;
each of said one or more service providers configured to acquire, from a user device, one or more tokens/certificates after consent from the user device, and further configured to get access to a global ID of the user device, the global ID including attributes wherein said attributes include at least consents of the user, wherein the user consents to what services and data should be available to share;
each of said one or more service providers receiving said consents from the user; and
the one or more service providers configured to request from the user device the right to read capabilities or specific user data.

37. The system according to claim 36, wherein each of the one or more service providers is configured to expose or share its capabilities for its service independently of the user's selection, and the one or more service providers is configured to use the global ID of the user to register user capabilities in a service and capability catalogue.

38. The system according to claim 36, wherein each of said one or more service providers is configured to scan the user's service provider associations.

39. The system according to claim 38, wherein if consent from the user is received and accepted by one or more service providers, the one or more service providers is configured to request association with capabilities of other service providers.

40. The system according to claim 39, wherein if the user consents to the association, at least one token/certificate is transferred for at least one capability to a service selected by the user.
